(19) United States
(12) Patent Application Publication
(10) Pub. No.: US 2025/0100047 A1
(43) Pub. Date: Mar. 27, 2025

(54) Additive Manufacturing Powder And Additively Manufactured Body

(71) Applicant: SEIKO EPSON CORPORATION, Tokyo (JP)

(72) Inventors: Momoko WAKABAYASHI, Hachinohe (JP); Yasutaka MATSUMOTO, Suwa (JP)

(21) Appl. No.: 18/890,954

(22) Filed: Sep. 20, 2024

(30) Foreign Application Priority Data
Sep. 22, 2023 (JP) 2023-158918

(51) Int. Cl. B22F 1/16; B22F 10/14; B33Y 70/00

(52) U.S. Cl. CPC B22F 1/16; B22F 10/14; B33Y 70/00

(57) ABSTRACT

An additive manufacturing powder used for producing an additively manufactured body by a binder-jet method includes a metal particle and a coating film provided at a surface of the metal particle and containing a compound derived from a coupling agent containing an amino group or an epoxy group. When 40 μL of water is dropped onto a powder layer formed by compressing to have a relative density of 51%, a time for the water to infiltrate is 10.00 seconds or shorter.

The present application is based on, and claims priority from JP Application Serial Number 2023-158918, filed Sep. 22, 2023, the disclosure of which is hereby incorporated by reference herein in its entirety.

### BACKGROUND

### 1. Technical Field

The disclosure relates to an additive manufacturing powder and an additively manufactured body.

### 2. Related Art

As a technique for modeling a three-dimensional object, an additive manufacturing method using a metal powder is widely used in recent years. As one of such additive manufacturing methods, a binder-jet method is known.

JP-T-2006-515813 discloses a solid freeform fabrication system which ejects droplets different in volume as droplets of a binder to a powder layer using an inkjet printing technique, solidifies the powder to produce an object. A method of producing an object using such a system includes a step of ejecting droplets of a binder, and thus can be regarded as a type of the binder-jet method. According to such a system, it is possible to produce an object finished to have a smooth surface by ejecting droplets different in volume.

JP-T-2006-515813 is an example of the related art.

In the binder-jet method, a water-based liquid (water-based binder solution) is often used as droplets of a binder. When the water-based binder solution infiltrates a powder layer, such a portion can be solidified.

However, depending on a powder surface state, the water-based binder solution may not rapidly infiltrate the powder layer. In this case, since it takes time to infiltrate, a supply speed of the water-based binder solution may decrease, or an infiltration range may become uneven. Thus, a production speed of an object (modeled body) decreases, and surface accuracy of the produced object decreases.

### SUMMARY

An additive manufacturing powder according to an application example of the disclosure is
an additive manufacturing powder used for producing an additively manufactured body by a binder-jet method, the additive manufacturing powder containing:
a metal particle; and
a coating film provided at a surface of the metal particle and containing a compound derived from a coupling agent containing an amino group or an epoxy group, in which
when 40 μL of water is dropped onto a powder layer formed by compressing to have a relative density of 51%, a time for the water to infiltrate is 10.00 seconds or shorter.

An additively manufactured body according to an application example of the disclosure is
an additively manufactured body containing:
the additive manufacturing powder according to the application example of the disclosure; and
a binder that binds particles of the additive manufacturing powder.

### BRIEF DESCRIPTION OF THE DRAWINGS

FIG. 1 is a step diagram showing an example of a method for producing an additively manufactured body.

FIG. 2 shows the method for producing an additively manufactured body shown in FIG. 1.

FIG. 3 shows the method for producing an additively manufactured body shown in FIG. 1.

FIG. 4 shows the method for producing an additively manufactured body shown in FIG. 1.

FIG. 5 shows the method for producing an additively manufactured body shown in FIG. 1.

FIG. 6 shows the method for producing an additively manufactured body shown in FIG. 1.

FIG. 7 shows the method for producing an additively manufactured body shown in FIG. 1.

FIG. 8 shows the method for producing an additively manufactured body shown in FIG. 1.

FIG. 9 shows the method for producing an additively manufactured body shown in FIG. 1.

FIG. 10 shows the method for producing an additively manufactured body shown in FIG. 1.

FIG. 11 is a cross-sectional view schematically showing an additive manufacturing powder according to an embodiment.

FIG. 12 is an example of an infrared absorption spectrum obtained from the additive manufacturing powder when the additive manufacturing powder contains an amino group.

FIG. 13 is an example of an infrared absorption spectrum obtained from the additive manufacturing powder when the additive manufacturing powder contains an epoxy group.

### DESCRIPTION OF EMBODIMENTS

Hereinafter, a preferred embodiment of an additive manufacturing powder and an additively manufactured body in the disclosure will be described in detail with reference to the accompanying drawings.

### 1. Method for Producing Additively Manufactured Body

First, an example of a method for producing an additively manufactured body using an additive manufacturing powder will be described.

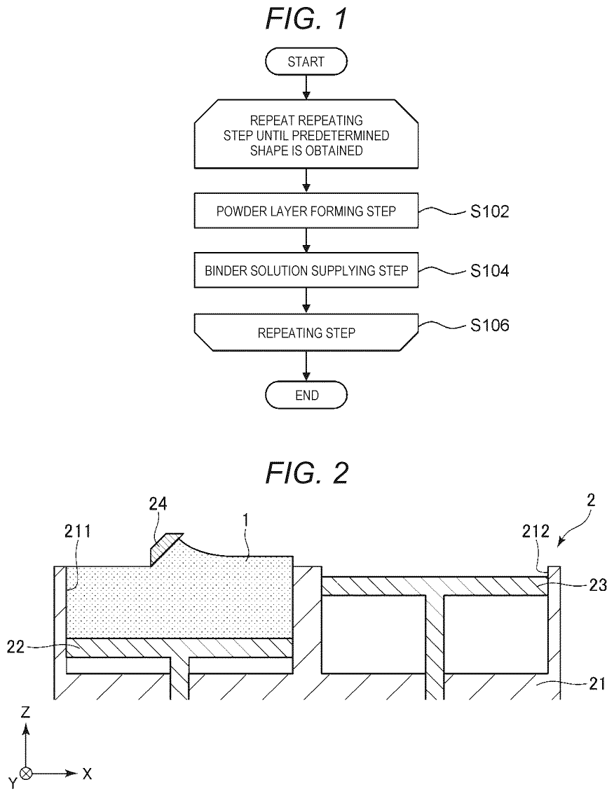

FIG. 1 is a step diagram showing the example of the method for producing an additively manufactured body. FIGS. 2 to 10 show the method for producing an additively manufactured body shown in FIG. 1. In FIGS. 2 to 10, three axes orthogonal to each other are set as an X axis, a Y axis, and a Z axis. Each axis is indicated by an arrow, and a tip side thereof is referred to as a “plus side” whereas a base side thereof is referred to as a “minus side”. In the following description, in particular, a plus side of the Z axis is referred to as “upper”, and a minus side of the Z axis is referred to as “lower”. In addition, both directions parallel to the X axis are referred to as an X-axis direction, both directions parallel to the Y axis are referred to as a Y-axis direction, and both directions parallel to the Z axis are referred to as a Z-axis direction.

The method for producing an additively manufactured body shown in FIGS. 1 to 10 is a method called a binder-jet method, which is a type of an additive manufacturing method, and includes a powder layer forming step S102, a binder solution supplying step S104, and a repeating step S106 as shown in FIG. 1. The binder-jet method does not require a support structure for supporting an additively manufactured body, and thus has an advantage that an additively manufactured body having a complicated shape can be produced.

In the powder layer forming step S102, an additive manufacturing powder 1 is spread to form a powder layer 31. In the binder solution supplying step S104, a binder solution 4 is supplied to a predetermined region of the powder layer 31, and particles in the powder layer 31 are bound to each other to obtain a bound layer 41. In the repeating step S106, the powder layer forming step S102 and the binder solution supplying step S104 are repeated once or more to obtain an additively manufactured body 6 shown in FIG. 10. The produced additively manufactured body 6 is subjected to a sintering treatment to form a metal sintered body. Since a shape of the additively manufactured body is reflected in the obtained metal sintered body, a metal sintered body having a complicated shape can be efficiently produced. Hereinafter, each step will be sequentially described.

### 1.1. Additive Manufacturing Apparatus

First, prior to description of the powder layer forming step S102, an additive manufacturing apparatus 2 will be described.

The additive manufacturing apparatus 2 includes an apparatus main body 21 including a powder storage unit 211 and a modeling unit 212, a powder supply elevator 22 provided at the powder storage unit 211, a modeling stage 23 provided at the modeling unit 212, and a coater 24, a roller 25, and a liquid supply unit 26 which are movably provided on the apparatus main body 21.

The powder storage unit 211 is a recess which is provided at the apparatus main body 21 and an upper portion of which opens. The additive manufacturing powder 1 is stored in the powder storage unit 211. An appropriate amount of the additive manufacturing powder 1 stored in the powder storage unit 211 is supplied to the modeling unit 212 by the coater 24.

The powder supply elevator 22 is disposed at a bottom portion of the powder storage unit 211. The powder supply elevator 22 is movable in an upper-lower direction in a state in which the additive manufacturing powder 1 is placed thereon. By moving the powder supply elevator 22 upward, the additive manufacturing powder 1 placed on the powder supply elevator 22 is pushed up to protrude from the powder storage unit 211. Accordingly, a protruding part of the additive manufacturing powder 1 can be moved toward the modeling unit 212.

The modeling unit 212 is a recess which is provided at the apparatus main body 21 and an upper portion of which opens. The modeling stage 23 is disposed inside the modeling unit 212. On the modeling stage 23, the additive manufacturing powder 1 is spread in layers by the coater 24. The modeling stage 23 is movable in the upper-lower direction in a state in which the additive manufacturing powder 1 is spread thereon. By appropriately setting a height of the modeling stage 23, an amount of the additive manufacturing powder 1 spread on the modeling stage 23 can be adjusted.

The coater 24 and the roller 25 extend in the Y-axis direction and are movable in the X-axis direction from the powder storage unit 211 to the modeling unit 212. The coater 24 can level and spread the additive manufacturing powder 1 in a layered manner by dragging the additive manufacturing powder 1. The roller 25 compresses the additive manufacturing powder 1 from above by rolling on the additive manufacturing powder 1 thus leveled.

The liquid supply unit 26 is implemented by, for example, an inkjet head and a dispenser, and is movable in the X-axis direction and the Y-axis direction at the modeling unit 212. The liquid supply unit 26 can supply an intended amount of the binder solution 4 to an intended position. The liquid supply unit 26 may include a plurality of ejection nozzles at one head. The binder solution 4 may be ejected simultaneously or with a time difference from the plurality of ejection nozzles.

### 1.2. Powder Layer Forming Step

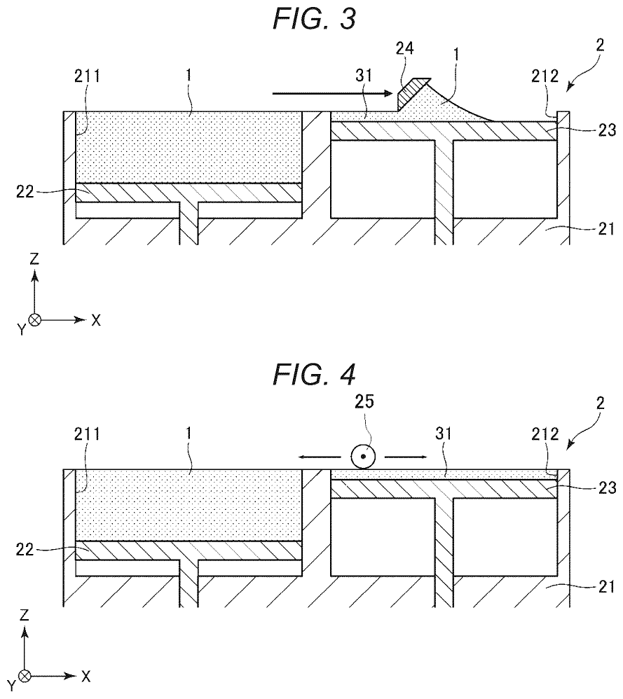

Next, the powder layer forming step S102 using the additive manufacturing apparatus 2 will be described. In the powder layer forming step S102, the additive manufacturing powder 1 is spread on the modeling stage 23 to form the powder layer 31. Specifically, as shown in FIGS. 2 and 3, using the coater 24, the additive manufacturing powder 1 stored in the powder storage unit 211 is dragged onto and leveled on the modeling stage 23 to have a uniform thickness. Accordingly, the powder layer 31 shown in FIG. 4 is obtained. At this time, a thickness of the powder layer 31 can be adjusted by lowering an upper surface of the modeling stage 23 below an upper end of the modeling unit 212 and adjusting a lowering amount. As will be described later, the additive manufacturing powder 1 is a powder having excellent fillability when being leveled. Therefore, the powder layer 31 having a high filling ratio can be obtained.

Next, as shown in FIG. 4, the roller 25 is moved in the X-axis direction while compressing the powder layer 31 in a thickness direction by the roller 25. Accordingly, a filling ratio of the additive manufacturing powder 1 in the powder layer 31 can be increased. The compression by the roller 25 may be performed as necessary, and may be omitted. The powder layer 31 may be compressed by a device different from the roller 25, such as a pressing plate.

### 1.3. Binder Solution Supplying Step

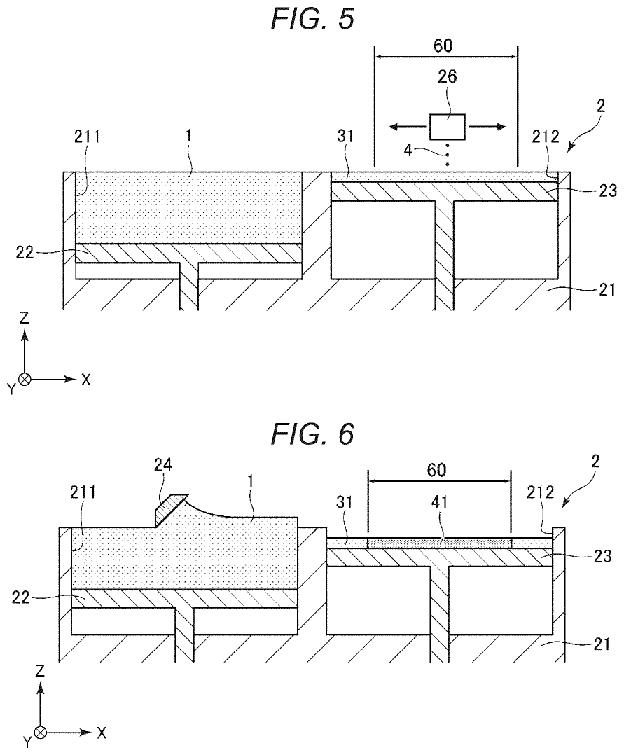

In the binder solution supplying step S104, as shown in FIG. 5, the liquid supply unit 26 supplies the binder solution 4 to a forming region 60 corresponding to the additively manufactured body 6 to be modeled in the powder layer 31. The binder solution 4 is a liquid containing a binder and a solvent or a dispersion medium. In the forming region 60 to which the binder solution 4 is supplied, particles of the additive manufacturing powder 1 are bound to each other, and the bound layer 41 shown in FIG. 6 is obtained. In the bound layer 41, the particles of the additive manufacturing powder 1 are bound to each other with the binder, and the binding layer 41 has shape retention performance to an extent that the binding layer 41 is not broken by own weight.

The bound layer 41 may be heated simultaneously with or after the supply of the binder solution 4. Accordingly, volatilization of the solvent or the dispersion medium contained in the binder solution 4 is promoted, and solidification or curing of the binder promotes binding of the particles. When the binder contains a photo-curable resin or a UV-curable resin, light irradiation or UV irradiation may be performed instead of heating or together with heating.

A heating temperature in the heating is not particularly limited, and is preferably 50° C. or higher and 250° C. or lower, and more preferably 70° C. or higher and 200° C. or lower. Accordingly, a sufficient amount of heat can be applied to the bound layer 41, and the volatilization of the solvent or the dispersion medium can sufficiently be promoted.

The binder solution 4 is not particularly limited as long as the binder solution 4 is a liquid containing a component that can bind the particles of the additive manufacturing powder 1. Examples of the solvent contained in the binder solution 4 include water, alcohols, ketones, and carboxylic acid esters, and the solvent may be a mixed liquid containing at least one of the above. Among these, water is preferably used as the solvent. The binder solution 4 containing water can reduce an environmental burden as compared with a case where an organic solvent is contained.

A content of water in the binder solution 4 is preferably 60 mass % or more, more preferably 70 mass % or more, and still more preferably 80 mass % or more. Accordingly, a ratio of water in the binder solution 4 can be sufficiently high, and an environmental burden at the time of drying or disposal of the binder solution 4 can be reduced.

Examples of the binder contained in the binder solution 4 include fatty acids, paraffin waxes, microcrystalline waxes, polyethylene, polypropylene, polystyrene, acrylic resins, polyamide resins, polyesters, stearic acid, polyvinyl pyrrolidone (PVP), polyvinyl alcohol (PVA), polyethylene glycol (PEG), urethane resins, epoxy resins, vinyl resins, unsaturated polyester resins, and phenolic resins.

Among these, polyvinyl alcohol (PVA) or polyvinyl pyrrolidone (PVP) is preferably used as the binder. The binder solution 4 containing such a binder has a suitable affinity and a suitable viscosity for the additive manufacturing powder 1, and also has a favorable binding property. Therefore, the binder solution 4 contributes to production of the additively manufactured body 6 having particularly favorable surface accuracy.

Any additive may be added to the binder solution 4. Examples of the additive include a viscosity modifier, a surfactant, a humectant, a stabilizer, an antifoaming agent, a crosslinking agent, and an antioxidant.

A concentration of the binder in the binder solution 4 is preferably 0.1 mass % or more and 20.0 mass % or less, more preferably 1.0 mass % or more and 15.0 mass % or less, and still more preferably 5.0 mass % or more and 12.0 mass % or less. Accordingly, the viscosity of the binder solution 4 is optimized, and a sufficient binding force between the particles of the additive manufacturing powder 1 can be ensured.

A surface tension of the binder solution 4 is preferably set to 20 mN/m or more and 40 mN/m or less, more preferably set to 20 mN/m or more and 35 mN/m or less, and still more preferably set to 20 mN/m or more and 30 mN/m or less. Accordingly, a driving force of infiltration due to a capillary action in the powder layer 31 is appropriately applied to the binder solution 4. As a result, an infiltration rate of the binder solution 4 in the powder layer 31 can be sufficiently high.

When the surface tension of the binder solution 4 is smaller than the lower limit value, the driving force of infiltration due to the capillary action does not sufficiently act on the binder solution 4 supplied to the powder layer 31. Therefore, the infiltration rate may not be sufficiently high. On the other hand, when the surface tension of the binder solution 4 exceeds the upper limit value, the surface tension becomes excessive, and thus droplets of the binder solution 4 are likely to be spherical. Therefore, the binder solution 4 may not easily infiltrate the powder layer 31.

The surface tension of the binder solution 4 is measured using a surface tension meter. An example of the surface tension meter is a surface tension meter CBVP-Z manufactured by Kyowa Interface Science Co., Ltd.

### 1.4. Repeating Step

In the repeating step S106, the powder layer forming step S102 and the binder solution supplying step S104 are repeated once or more until a stacked body formed by stacking a plurality of bound layers 41 has a predetermined shape. That is, these steps are performed twice or more in total. Accordingly, the three-dimensional additively manufactured body 6 shown in FIG. 10 is obtained.

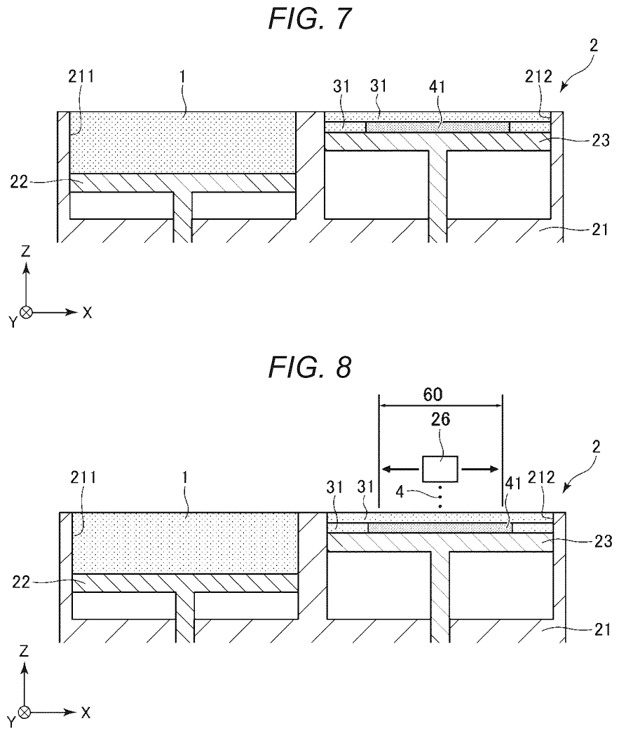

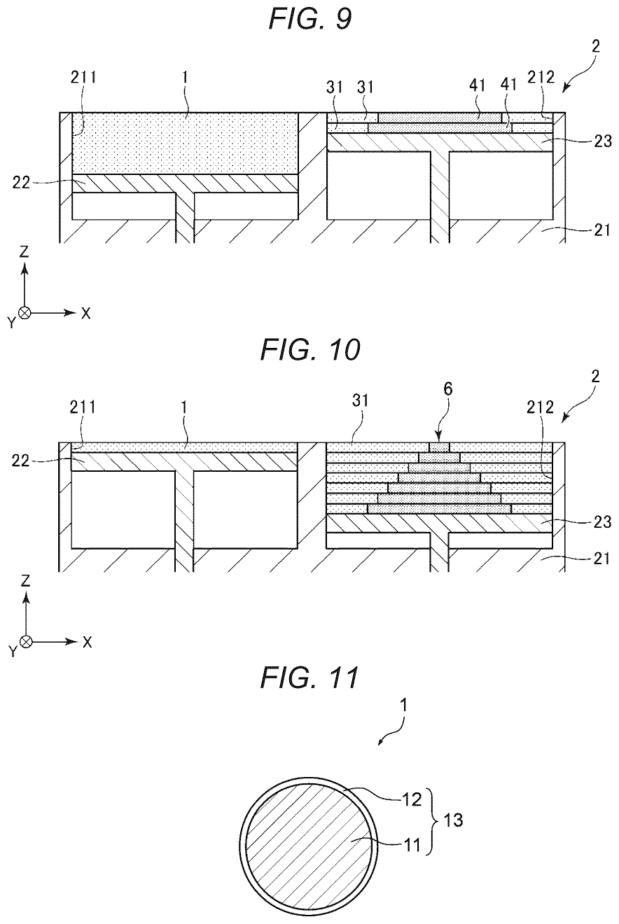

Specifically, first, as shown in FIG. 7, the new powder layer 31 is formed on the bound layer 41 shown in FIG. 6. Next, as shown in FIG. 8, the binder solution 4 is supplied to the forming region 60 in the newly formed powder layer 31. Accordingly, the bound layer 41 as a second layer shown in FIG. 9 is obtained. By repeating such operations, the additively manufactured body 6 shown in FIG. 10 is obtained.

In the powder layer 31, the additive manufacturing powder 1 that does not constitute the bound layers 41 is collected and reused as necessary, that is, used again for producing the additively manufactured body 6.

### 1.5. Method for Producing Metal Sintered Body

By subjecting the additively manufactured body 6 to the sintering treatment, a metal sintered body is obtained. In the sintering treatment, the additively manufactured body 6 is heated to cause a sintering reaction.

A sintering temperature varies depending on a constituent material, a particle diameter, and the like of the additive manufacturing powder 1, and as an example, is preferably 980° C. or higher and 1450° C. or lower, and more preferably 1050° C. or higher and 1350° C. or lower. A sintering time is preferably 0.2 hours or longer and 7 hours or shorter, and more preferably 1 hour or longer and 6 hours or shorter.

An atmosphere in the sintering treatment is, for example, a reducing atmosphere such as hydrogen, an inert atmosphere such as nitrogen or argon, or a reduced-pressure atmosphere obtained by reducing a pressure of such an atmosphere. The pressure in the reduced-pressure atmosphere is not particularly limited as long as the pressure is lower than a normal pressure (100 kPa), and is preferably 10 kPa or less, and more preferably 1 kPa or less.

When the sintering treatment performed under the above-described conditions is referred to as “main sintering”, “pre-sintering” or “debindering” corresponding to a pretreatment of the main sintering may be performed on the additively manufactured body 6 as necessary. Accordingly, at least a part of the binder contained in the additively manufactured body 6 can be removed, or a sintering reaction can be caused in a portion. Accordingly, when the main sintering is performed, unintended deformation or the like can be prevented.

A temperature in the pre-sintering or the debindering is not particularly limited as long as the temperature is a temperature at which sintering of a metal powder is not completed, and is preferably 100° C. or higher and 500° C. or lower, and more preferably 150° C. or higher and 300° C. or lower. A duration of the pre-sintering or the debindering in the temperature range described above is preferably 5 minutes or longer, more preferably 10 minutes or longer and 120 minutes or shorter, and still more preferably 20 minutes or longer and 60 minutes or shorter. An atmosphere in the pre-sintering or the debindering is, for example, an ambient atmosphere, an inert atmosphere such as nitrogen or argon, or a reduced-pressure atmosphere obtained by reducing a pressure of such an atmosphere.

The metal sintered body obtained as described above can be used as a material constituting all or a part of a component for transportation equipment such as a component for an automobile, a component for a bicycle, a component for a railway vehicle, a component for a ship, a component for an aircraft, or a component for a spacecraft, a component for an electronic device such as a component for a personal computer, a component for a mobile phone terminal, a component for a tablet terminal, or a component for a wearable terminal, a component for electrical equipment such as a refrigerator, a washing machine, or a cooling and heating machine, a component for a machine such as a machine tool or a semi-conductor manufacturing apparatus, a component for a plant such as a nuclear power plant, a thermal power plant, a hydroelectric power plant, an oil refinery, or a chemical complex, a component for a timepiece, a metal utensil, and a decorative item such as jewelry or an eyeglass frame.

### 2. Additive Manufacturing Powder

Next, the additive manufacturing according to the embodiment will be described.

FIG. 11 is a cross-sectional view schematically showing the additive manufacturing powder according to the embodiment.

The additive manufacturing powder 1 according to the embodiment is, for example, a powder used for producing the additively manufactured body 6 by the above-described binder-jet method.

The additive manufacturing powder 1 shown in FIG. 11 contains a plurality of surface-coated particles 13 each containing a metal particle 11 that contains a metal material and a coating film 12 covering a surface of the metal particle 11. The coating film 12 contains a compound derived from a coupling agent containing an amino group. The coating film 12 preferably covers the entire surface of the metal particle 11, or there may be a portion that is not covered.

### 2.1. Metal Particle

The metal material contained in the metal particle 11 is not particularly limited, and may be any material as long as the metal material has sinterability. Examples thereof include simple substances of Fe, Ni, Co, and Ti, and alloys and intermetallic compounds containing such simple substances as main components.

An Fe-based metal material is preferably used as the metal material. The Fe-based metal material refers to a metal material having an Fe content of more than 50% in terms of an atomic ratio. The Fe-based metal material is easily available and can be used to produce a metal sintered body having excellent mechanical properties.

Examples of the Fe-based metal material include stainless steel such as ferritic stainless steel, austenitic stainless steel, martensitic stainless steel, precipitation-hardening stainless steel, and austenitic-ferritic (duplex) stainless steel, low-carbon steel, carbon steel, heat-resistant steel, die steel, high-speed tool steel, an Fe—Ni alloy, and an Fe—Ni—Co alloy.

Among these, stainless steel is preferably used as the Fe-based metal material. Stainless steel is a type of steel excellent in mechanical strength and corrosion resistance. Therefore, by using the additive manufacturing powder 1 made of stainless steel, a metal sintered body having excellent mechanical strength and corrosion resistance and having high shape accuracy can be efficiently produced.

Examples of the austenitic stainless steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of the ferritic stainless steel include SUS405, SUS410L, SUS429, SUS430, SUS 430LX, SUS430J1L, SUS434, SUS 436L, SUS 436J1L, SUS445J1, SUS445J2, SUS444, SUS447J1, and SUSXM27.

Examples of the martensitic stainless steel include SUS403, SUS410, SUS410S, SUS420J1, SUS420J2, and SUS440A.

Examples of precipitation-hardening the stainless steel include SUS630 and SUS631.

Examples of the austenitic-ferritic (duplex) stainless steel include SUS329J1, SUS329J3L, and SUS329J4L.

The above-described symbols are material symbols based on the JIS standards. The types of stainless steel in the specification are distinguished by the above-described material symbols.

The additively manufactured body 6 may be produced using two or more types of additive manufacturing powders 1 containing different types of metal materials. For example, the additively manufactured body 6 may be divided into two portions, one portion may be produced using the additive manufacturing powder 1 made of a first metal material, and the other portion may be produced using the additive manufacturing powder 1 made of a second metal material.

### 2.2. Coating Film

The coating film 12 is formed by reacting the coupling agent containing an amino group or an epoxy group with the surface of the metal particle 11. Therefore, the coating film 12 contains a compound derived from the coupling agent containing the amino group or the epoxy group, and exhibits properties derived from the amino group or the epoxy group.

Examples of the coupling agent include compounds containing an amino group or an epoxy group and a hydrolyzable group, specifically, a silane coupling agent, a titanium coupling agent, and a zirconium coupling agent.

The following chemical formula is an example of a molecular structure of the silane coupling agent.

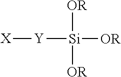

In the above formula, X is a functional group, and is an amino group or an epoxy group. In addition, Y is a spacer, and OR is a hydrolyzable group. In addition, R is, for example, a methyl group or an ethyl group.

The hydrolyzable group is, for example, an alkoxy group or a halogen group, and generates silanol by hydrolysis. The silanol reacts with a hydroxy group generated at the surface of the metal particle, and a compound derived from the coupling agent is generated at the surface of the metal particle.

The coupling agent may contain at least one hydrolyzable group, and preferably contains two or more, and more preferably contains three hydrolyzable groups as in the above formula. The coupling agent containing three hydrolyzable groups reacts with three hydroxy groups generated at the surface of the metal particle. Therefore, the coating film 12 derived from the coupling agent has favorable adhesion to the metal particle 11. Since the coupling agent containing three hydrolyzable groups also has excellent film-forming properties, it is possible to obtain the coating film 12 having excellent continuity. Such the coating film 12 contributes to further improving fluidity of the additive manufacturing powder 1.

Both the amino group and the epoxy group have appropriate hydrophilicity. That is, the amino group and the epoxy group do not have strong hydrophobicity and are not extremely hydrophilic. Therefore, when the amino group or the epoxy group is imparted to the coating film 12, appropriate hydrophilicity is imparted to the coating film 12. Accordingly, even when the binder solution 4 is water-based, an affinity between the powder layer 31 and the binder solution 4 can be high. As a result, the binder solution 4 can rapidly infiltrate the powder layer 31, thus a decrease in a supply speed of the binder solution 4 can be avoided, and unevenness in an infiltration range can be prevented.

The spacer Y is a single bond or a divalent linking group, and is, for example, a group containing an alkylene group, a cycloalkylene group, an arylene group, or an aralkylene group. Such a group has hydrophobicity derived from hydrocarbons and imparts hydrophobicity to the coating film 12. Accordingly, it is possible to obtain the additive manufacturing powder 1 in which the coating film 12 is less likely to absorb moisture even in a high-humidity environment and whose fluidity is thus less likely to decrease.

The spacer Y is particularly preferably an alkylene group. Accordingly, a compound having moderate hydrophobicity is obtained while reducing bulkiness of molecules of the coupling agent, and therefore moderate hydrophobicity is imparted to the coating film 12 without unevenness. The linking group may be unsubstituted or substituted with a substituent. In addition, the spacer Y may contain another structure such as an oxygen atom or a sulfur atom.

The number of carbon atoms in the spacer Y is preferably 1 or more and 18 or less, more preferably 2 or more and 10 or less, still more preferably 3 or more and 8 or less, and particularly preferably 3 or more and 6 or less. The number of carbon atoms in the spacer Y affects the hydrophobicity of the compound derived from the coupling agent. Therefore, when the number of carbon atoms in the spacer Y is within the above range, a balance between the hydrophilicity due to the amino group or the epoxy group and the hydrophobicity due to the spacer Y is particularly favorable. As a result, even when the binder solution 4 is water-based, the additive manufacturing powder 1 that can form the powder layer 31 enabling rapid infiltration is obtained.

Examples of the coupling agent containing the amino group include 3-aminopropyltrimethoxysilane, 3-aminopropyltriethoxysilane, 3-aminopropyltriisopropoxysilane, 3-aminopropylmethyldimethoxysilane, 3-aminopropylmethyldiethoxysilane, N-(2-aminoethyl)-3-aminoisobutyldimethylmethoxysilane, N-(2-aminoethyl)-3-aminoisobutylmethyldimethoxysilane, (aminoethylaminomethyl)phenethyltriethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropylsilanetriol, N-(2-aminoethyl)-3-aminopropyltriethoxysilane, N-(2-aminoethyl)-3-aminopropyltrimethoxysilane, N-(2-aminoethyl)-3-aminopropyltriisopropoxysilane, N-(6-aminohexyl)-3-aminomethyltrimethoxysilane, N-(6-aminohexyl)-3-aminomethyltriethoxysilane, N-2-(aminoethyl)-8-aminooctyltrimethoxysilane, N-(2-aminoethyl)-11-aminoundecyltrimethoxysilane, N-3-[amino(polypropyleneoxy)]aminopropyltrimethoxysilane, 3-ureidopropyltrimethoxysilane, N-phenyl-3-aminopropyltrimethoxysilane, N-benzyl-3-aminopropyltrimethoxysilane, and N-vinylbenzyl-3-aminopropyltriethoxysilane.

Among these, a coupling agent containing a secondary amine is preferably used. The secondary amine is contained in, for example, the spacer Y, and acts to reduce the hydrophobicity of the spacer Y. Therefore, a compound derived from the coupling agent containing the secondary amine can result in the coating film 12 having a better affinity with the water-based binder solution 4.

A coupling agent containing both a primary amine and a secondary amine is more preferably used. Accordingly, the coating film 12 having a particularly excellent affinity with the water-based binder solution 4 can be obtained.

Examples of the coupling agent containing the epoxy group include 3-glycidoxypropyltrimethoxysilane, 3-glycidoxypropyltriethoxysilane, 3-glycidoxypropylmethyldimethoxysilane, 2-(3,4-epoxycyclohexyl)ethyltrimethoxysilane, and 2-(3,4-epoxycyclohexyl)ethyltriethoxysilane.

An average thickness of the coating film 12 is not particularly limited, and is preferably 100 nm or less, more preferably 0.5 nm or more and 50 nm or less, and still more preferably 1 nm or more and 10 nm or less. Accordingly, a film thickness necessary for maintaining the coating film 12 is ensured.

The average thickness of the coating film 12 can be specified by, for example, qualitative and quantitative analysis in a depth direction using X-ray photoelectron spectroscopy and ion sputtering in combination. Specifically, a concentration of the component derived from the coupling agent is examined along the depth direction. A region where the concentration of the component derived from the coupling agent is relatively high is defined as the average thickness of the coating film 12. Specifically, when the concentration is changed in the vicinity of a boundary between the coating film 12 and the metal particle 11, a position corresponding to a half of an amount of change in the concentration, that is, a midpoint between the concentration on the coating film 12 side and the concentration on the metal particle 11 side is regarded as the boundary, and a thickness from the boundary to a surface side may be set as the average thickness of the coating film 12.

The coating film 12 may be a multilayer film in which molecules of the above-described compound are stacked in a plurality of layers, for example, two or more layers and ten or less layers, and is preferably a monomolecular film formed of the compound described above. A thickness of the coating film 12, which is a monomolecular film, can be minimized. As a result, when the additively manufactured body 6 is produced, the additively manufactured body 6 in which an occupancy rate of the coating film 12 is low whereas an occupancy rate of the metal particle 11 is high can be obtained. Such the additively manufactured body 6 is useful in obtaining a metal sintered body with high shape accuracy, for example, since a shrinkage rate is reduced when being subjected to the sintering treatment.

The monomolecular film can be formed using self-assembly of the coupling agent. Since the coupling agent is densely arranged on the surface of the metal particle 11, the monomolecular film can be efficiently formed.

As for whether the coating film 12 is a monomolecular film, for example, when the average thickness of the coating film 12 measured by the above-described method is equal to or less than a molecular size of the coupling agent, the coating film 12 can be evaluated as a monomolecular film.

The coating film 12 may contain any component other than the compound described above. In this case, from the viewpoint of reliably obtaining the above-described effects, a mass ratio of the compound described above is preferably more than 50%, more preferably 70% or more, and still more preferably 90% or more.

### 2.3. Various Characteristics of Additive Manufacturing Powder

Next, various characteristics of the additive manufacturing powder 1 will be described.

### 2.3.1. Water Infiltration Time

A powder layer is formed using the additive manufacturing powder 1 according to the embodiment. Hydrophilicity of the powder layer can be quantitatively evaluated by measuring a time for water to infiltrate. The water infiltration time is measured as follows.

First, the additive manufacturing powder 1 charged in a container is compressed to form the powder layer such that a relative density is 51%. The relative density of the powder layer is calculated based on a volume obtained from an area and a thickness of the powder layer and mass of the powder layer. A size of a forming range of the powder layer is 5 mm or more×5 mm or more, and the thickness of the powder layer is 5 mm or more. Next, 40 μL of water is supplied to the powder layer as droplets. As the water, pure water is used. Then, an elapsed time from a time of supply until all supplied water infiltrates the powder layer is measured as the water infiltration time.

In the powder layer formed using the additive manufacturing powder 1 according to the embodiment, the water infiltration time is preferably 10.00 seconds or shorter, more preferably 5.00 seconds or shorter, and still more preferably 2.00 seconds or shorter. When the water infiltration time is within this range, the powder layer 31 in which the infiltration rate of the water-based binder solution 4 is sufficiently high can be obtained. In such the powder layer 31, it is possible to allow the water-based binder solution 4 to infiltrate a target range without reducing the supply speed s of the binder solution 4. Therefore, an additively manufactured body having a high surface area degree can be efficiently produced.

The water infiltration time is also related to oxidation of the additive manufacturing powder 1 due to moisture, a decrease in the fluidity of the additive manufacturing powder 1 due to adsorption of moisture, and the like. Therefore, from the viewpoint of preventing the oxidation due to moisture, the decrease in the fluidity, and the like, the water infiltration time is preferably 0.01 seconds or longer, more preferably 0.05 seconds or longer, and still more preferably 0.10 seconds or longer.

When the water infiltration time exceeds the upper limit value, the water-based binder solution 4 cannot infiltrate the target range in the powder layer 31, or the supply speed of the binder solution 4 cannot be increased. On the other hand, when the water infiltration time is smaller than the lower limit value, the fillability of the additive manufacturing powder 1 in the powder layer 31 may decrease, or the additive manufacturing powder 1 may be denatured by oxidation.

### 2.3.2. Infrared Spectroscopic Analysis

The additive manufacturing powder 1 according to the embodiment can evaluate infiltration of the water-based binder solution 4 by being subjected to an infrared spectroscopic analysis. Specifically, first, the additive manufacturing powder 1 is subjected to the infrared spectroscopic analysis to obtain an infrared absorption spectrum. A Fourier transform infrared spectrometer is used for the infrared spectroscopic analysis. In particular, an ATR method is preferably used. Next, an intensity of each of a peak P1 derived from a siloxane bond (Si—O bond), a peak P2 derived from an amino group (NH2), and a peak P3 derived from an epoxy group (epoxy ring anti-symmetric stretching) in the infrared absorption spectrum is obtained.

A peak wavenumber of the peak P1 is located at 1140 to 1120 cm⁻¹. A peak wavenumber of the peak P2 is located at 1695 to 1650 cm⁻¹. A peak wavenumber of the peak P3 is located at 920 to 910 cm⁻¹.

In the additive manufacturing powder 1 according to the embodiment, the obtained infrared absorption spectrum has the peak P1 and the peak P2, or the peak P1 and the peak P3.

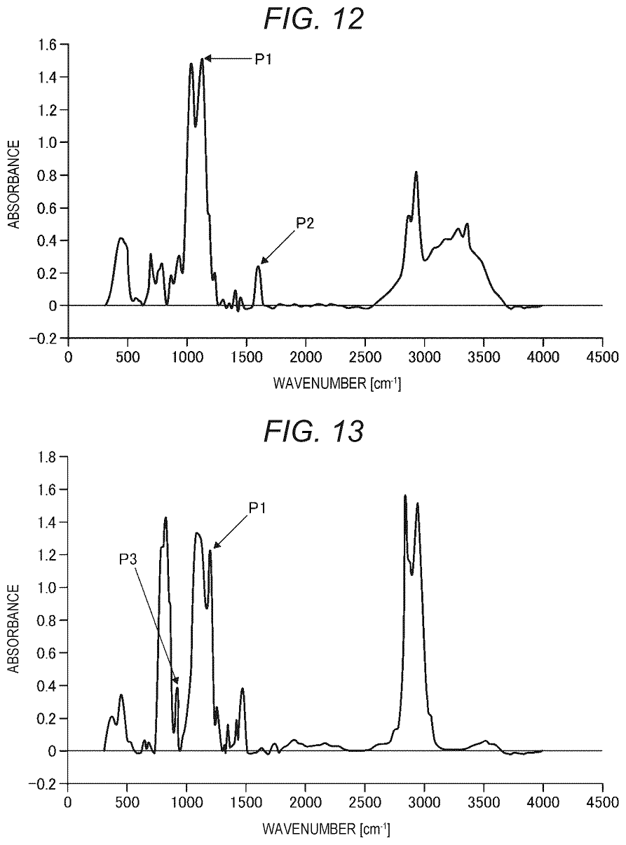

FIG. 12 is an example of an infrared absorption spectrum obtained from the additive manufacturing powder 1 when the additive manufacturing powder 1 contains an amino group.

When the additive manufacturing powder 1 contains an amino group, the intensity of the peak P2 shown in FIG. 12 is preferably 5% or more, more preferably 10% or more of the intensity of the peak P1. When the peaks P1 and P2 satisfy such an intensity ratio, a presence ratio of the amino group to a surface of the additive manufacturing powder 1 can be sufficiently high. As a result, the additive manufacturing powder 1 that can form the powder layer 31 in which the water infiltration rate is particularly optimized is obtained.

An upper limit value of the intensity of the peak P2 is preferably 70% or less, more preferably 50% or less, and still more preferably 40% or less from the viewpoint of ensuring a sufficient ratio of the siloxane bond and obtaining adhesion strength of the coating film 12.

When the intensity of the peak P2 is smaller than the lower limit value, the water infiltration rate in the powder layer 31 may not be sufficiently high when the powder layer 31 is formed using the additive manufacturing powder 1. On the other hand, when the intensity of the peak P2 exceeds the upper limit value, the siloxane bond is relatively insufficient, and the adhesion between the coating film 12 and the metal particle 11 may be insufficient.

FIG. 13 is an example of an infrared absorption spectrum obtained from the additive manufacturing powder 1 when the additive manufacturing powder 1 contains an epoxy group.

When the additive manufacturing powder 1 contains an epoxy group, the intensity of the peak P3 is preferably 5% or more, and more preferably 10% or more of the intensity of the peak P1. When the peaks P1 and P3 satisfy such an intensity ratio, a presence ratio of the epoxy group to the surface of the additive manufacturing powder 1 can be sufficiently high. As a result, the additive manufacturing powder 1 that can form the powder layer 31 in which the water infiltration rate is particularly optimized is obtained.

An upper limit value of the intensity of the peak P3 is preferably 70% or less, more preferably 50% or less, and still more preferably 40% or less from the viewpoint of ensuring a sufficient ratio of the siloxane bond and obtaining adhesion strength of the coating film 12.

When the intensity of the peak P3 is smaller than the lower limit value, the water infiltration rate in the powder layer 31 may not be sufficiently high when the powder layer 31 is formed using the additive manufacturing powder 1. On the other hand, when the intensity of the peak P3 exceeds the upper limit value, the siloxane bond is relatively insufficient, and the adhesion between the coating film 12 and the metal particle 11 may be insufficient.

### 2.3.3. Coverage Ratio

A ratio of an area covered by the coating film 12 to the entire surface of the metal particle 11 is referred to as a “coverage ratio”. In the additive manufacturing powder 1 according to the embodiment, the coverage ratio of the coating film 12 is preferably 10% or more and 150% or less, more preferably 20% or more and 90% or less, and still more preferably 30% or more and 80% or less. Accordingly, it is possible to obtain the additive manufacturing powder 1 that can form the powder layer 31 in which the water-based binder solution 4 can infiltrate the target range without decreasing the supply speed of the binder solution 4. In addition, in a case where a part of the surface of the metal particle 11 is exposed, a high affinity between the metal particle 11 and the water-based binder solution 4 can be obtained, and thus the infiltration rate can be further increased. As a result, the additively manufactured body 6 having a high surface area degree can be produced more efficiently.

When the coverage ratio is smaller than the lower limit value, the fluidity of the additive manufacturing powder 1 may decrease in a high-humidity environment. On the other hand, when the coverage ratio exceeds the upper limit value, the hydrophobicity of the coating film 12 increases depending on a molecular structure of the coupling agent, and the infiltration rate of the water-based binder solution 4 into the powder layer 31 may decrease. A state in which the coverage ratio exceeds 100% is a state in which two or more molecules of the compound derived from the coupling agent overlap at least a part of the surface of the metal particle 11 in a thickness direction.

The coverage ratio of the coating film 12 can be calculated based on an amount of the coating film 12, an amount of the metal particle 11, a minimum coverage area of the coupling agent, and a specific surface area of the metal particle 11. The amount of the coating film 12 can be calculated, for example, based on a concentration of a constituent element of the coupling agent by performing a qualitative and quantitative analysis by X-ray photoelectron spectroscopy on the additive manufacturing powder 1. For example, when the coupling agent is a silane coupling agent, an amount of a compound constituting the coating film 12 can be calculated based on a Si concentration. The minimum coverage area of the coupling agent is available from a manufacturer or the like for each type of the coupling agent. The specific surface area of the metal particle 11 is measured using a specific surface area measuring apparatus after removing the coating film 12 from the additive manufacturing powder 1 using, for example, a chemical. As the specific surface area measuring apparatus, for example, a BET type specific surface area measuring apparatus HM1201-010 manufactured by MOUNTECH Co., Ltd. may be used.

### 2.3.4. Particle Size Distribution

For the additive manufacturing powder 1 according to the embodiment, when a volume-based particle size distribution is obtained by a laser diffraction type particle size distribution measuring apparatus, a particle diameter when a cumulative frequency is 50% from a small diameter side is defined as D50. An example of the apparatus for measuring the particle size distribution is Microtrac HRA 9320-X100 manufactured by Nikkiso Co., Ltd.

The particle diameter D50 (average particle diameter) f the additive manufacturing powder 1 is preferably 1.0 μm or more and 15.0 μm or less, more preferably 3.0 μm or more and 12.0 μm or less, and still more preferably 4.0 μm or more and 10.0 μm or less. Accordingly, the additive manufacturing powder 1 that can produce the additively manufactured body 6 having excellent sinterability is obtained. In addition, the additive manufacturing powder 1 that has excellent fluidity and can form the powder layer 31 having a high filling degree is obtained.

When the particle diameter D50 is smaller than the lower limit value, particles of the additive manufacturing powder 1 may easily aggregate. When aggregation occurs, the fluidity of the additive manufacturing powder 1 may decrease, and a density of the metal sintered body may decrease. On the other hand, when the particle diameter D50 is larger than the upper limit value, sinterability of the additive manufacturing powder 1 decreases, and when the metal sintered body is obtained from the additively manufactured body 6, the density of the metal sintered body may decrease.

### 2.3.5. Water Contact Angle

The additive manufacturing powder 1 according to the embodiment preferably has a water contact angle of 80° or more and 125° or less, more preferably 85° or more and 120° or less, and still more preferably 90° or more and 110° or less as measured in a state of being spread in layers.

It can be said that the additive manufacturing powder 1 having a water contact angle in such a range has a particularly good balance between hydrophilicity and hydrophobicity. Therefore, by using the additive manufacturing powder 1, it is possible to form the powder layer 31 in which the water-based binder solution 4 can infiltrate the target range without decreasing the supply speed of the binder solution 4. Therefore, the additively manufactured body 6 having a high surface area degree can be efficiently produced. The additive manufacturing powder 1 in which the water contact angle is in the above range can reduce adsorption of moisture even in a high-humidity environment, and thus has excellent fluidity.

When the water contact angle is smaller than the lower limit value, oxidation due to moisture, a decrease in fluidity, and the like may occur. On the other hand, when the water contact angle exceeds the upper limit value, the infiltration rate of the water-based binder solution 4 may decrease due to the hydrophobicity of the coating film 12.

The water contact angle in the additive manufacturing powder 1 can be measured by the following procedure. First, a double-sided tape is attached to a flat surface. Next, the additive manufacturing powder 1 is spread on the double-sided tape. As the double-sided tape, for example, a polyester adhesive tape No. 31B, manufactured by Nitto Denko Corporation, of a type having a total thickness of 0.080 mm is used. Then, the spread additive manufacturing powder 1 is lightly pressed by a plate-like member. Next, the excessive additive manufacturing powder 1 is blown off by an air blower. Accordingly, a test specimen for contact angle measurement is obtained. An example of the air blower is a manual air blower used for cleaning a camera. Then, a tip of the air blower is fixed at a position 3 cm away from the test specimen and blowing is performed three times.

Next, a water contact angle of the test specimen is measured by a θ/2 method using a contact angle measuring apparatus Drop Master 500 manufactured by Kyowa Interface Science Co., Ltd. Measurement conditions are an air temperature of 25° C. and a relative humidity of 50%±5%. An amount of water dropped is 3 μL, and the measurement is performed 5 seconds after landing.

### 2.3.6. Bulk Density and Tapped Density

A bulk density AD of the additive manufacturing powder 1 according to the embodiment is preferably 2.50 g/cm³ or more and 3.70 g/cm³ or less, more preferably 2.70 g/cm³ or more and 3.60 g/cm³ or less, and still more preferably 3.00 g/cm³ or more and 3.50 g/cm³ or less. When the bulk density is within the above range, favorable fillability can be ensured even in a natural state. Accordingly, when the powder layer 31 is formed using the additive manufacturing powder 1, the powder layer 31 having a high filling ratio can be formed. As a result, the dense additively manufactured body 6 having high surface accuracy can be obtained, and by using the additively manufactured body 6, the metal sintered body having a high density and high surface accuracy can finally be produced.

The bulk density of the additive manufacturing powder 1 is measured according to a metal powder apparent density measurement method specified in JIS Z 2504:2012. In addition, for the measurement of the bulk density, a powder characteristic evaluation apparatus, Powder Tester (registered trademark) PT-X manufactured by Hosokawa Micron Corporation is preferably used. Before the bulk density is measured, the additive manufacturing powder 1 to be measured is preferably left to stand in an environment at a temperature of 25° C. and a relative humidity of 50% for 1 hour or longer.

A tapped density TD of the additive manufacturing powder 1 is preferably 4.10 g/cm³ or more and 4.80 g/cm³ or less, more preferably 4.20 g/cm³ or more and 4.70 g/cm³ or less, and still more preferably 4.30 g/cm³ or more and 4.60 g/cm³ or less. When the tapped density is within the above range, a high filling ratio can be obtained when the powder layer 31 is leveled by the modeling stage 23 or compressed by the roller 25. Accordingly, the dense additively manufactured body 6 having high surface accuracy can be obtained, and by using the additively manufactured body 6, the metal sintered body having a high density and high surface accuracy can finally be produced.

The tapped density of the additive manufacturing powder 1 is measured by a powder characteristic evaluation apparatus, Powder Tester (registered trademark) PT-X manufactured by Hosokawa Micron Corporation. Before the tapped density is measured, the additive manufacturing powder 1 to be measured is preferably left to stand in an environment at a temperature of 25° C. and a relative humidity of 50% for 1 hour or longer.

A ratio of the tapped density to the bulk density of the additive manufacturing powder 1 is preferably 1.10 or more and 1.60 or less, more preferably 1.15 or more and 1.50 or less, and still more preferably 1.20 or more and 1.40 or less. When the ratio is within the above range, a difference in the filling ratio between the additive manufacturing powder 1 in a natural state and the additive manufacturing powder 1 after vibration, load, or the like is applied can be reduced. Therefore, deformation or the like of the additively manufactured body 6 due to the difference in the filling ratio can be prevented. As a result, a metal sintered body having high surface accuracy is obtained.

Although the ratio may be less than the lower limit value, difficulty in stably producing the additive manufacturing powder 1 having such characteristics may increase. On the other hand, when the ratio exceeds the upper limit value, the difference in the filling ratio is large, which may cause deformation or the like of the additively manufactured body 6.

### 3. Method for Producing Additive Manufacturing Powder

Next, a method for producing the additive manufacturing powder 1 will be described.

The additive manufacturing powder 1 is produced through, for example, a preparation step, a coupling agent reaction step, and a coating film forming step.

### 3.1. Preparation Step

In the preparation step, a metal powder containing the metal particle 11 is prepared. The metal particle 11 may be produced by any method, and is preferably a powder produced by an atomization method such as a water atomization method, a gas atomization method, or a rotating water atomization method, and more preferably a powder produced by a water atomization method or a rotating water atomization method. A surface of the metal particle 11 produced by such a method is easily covered with a hydroxy group derived from water. Therefore, the adhesion of the coating film 12 can be improved, and the fluidity of the additive manufacturing powder 1 can be sufficiently high even when the coating film 12 is thin. As a result, it is possible to obtain the additively manufactured body 6 in which the occupancy rate of the metal particle 11 is higher than that of the coating film 12 and whose shrinkage rate at the time of sintering is small.

If necessary, the metal powder may be subjected to a known pretreatment for generating a hydroxy group on the surface of the metal particle 11.

### 3.2. Coupling Agent Reaction Step

In the coupling agent reaction step, the coupling agent is reacted with the metal powder. Examples of this operation include an operation of charging both the metal particle 11 and the coupling agent into a chamber and then heating the inside of the chamber (method 1), an operation of charging the metal particle 11 into a chamber and then spraying the coupling agent in the chamber while stirring the metal particle 11 (method 2), and an operation of charging a primary alcohol such as methanol, ethanol, or isopropyl alcohol into water, the coupling agent, and an alkali solution such as ammonia or sodium hydroxide, stirring, filtering, and then drying (method 3). The coupling agent is supplied by a method of static placement in the chamber or spraying into the chamber.

An amount of the coupling agent charged is not particularly limited, and is preferably 0.01 mass % or more and 1.00 mass % or less, and more preferably 0.05 mass % or more and 0.50 mass % or less, with respect to the metal particle 11.

### 3.3. Coating Film Forming Step

In the coating film forming step, the metal particle 11 to which the coupling agent adheres is heated. Accordingly, the coating film 12 is formed at the surface of the metal particle 11, and the additive manufacturing powder 1 is obtained. The unreacted coupling agent can be removed by heating.

A heating temperature for the metal particle 11 to which the coupling agent adheres is not particularly limited, and is preferably 50° C. or higher and 300° C. or lower, more preferably 100° C. or higher and 250° C. or lower, and still more preferably 120° C. or higher and 200° C. or lower. A heating time is preferably 10 minutes or longer and 24 hours or shorter, more preferably 30 minutes or longer and 10 hours or shorter, and still more preferably 1 hour or longer and 6 hours or shorter. The heating time is a time during which the heating temperature continues. An atmosphere in the heat treatment is, for example, an ambient atmosphere or an inert gas atmosphere.

It is preferable that at least one of the coupling agent reaction step and the coating film forming step is performed in a sealed container, and it is more preferable that both steps are performed in a sealed container. Accordingly, it is possible to prevent denaturation and volatilization of the coupling agent. As a result, a reaction amount and an adhesion density of the coupling agent can be suitably controlled, and finally, the coating film 12 having intended characteristics can be formed. In particular, since an amino group or an epoxy group is likely to cause an unintended reaction at the time of high-temperature heating, the additive manufacturing powder 1 having intended characteristics can be efficiently produced by performing the treatment in a sealed container.

### 4. Effects of Embodiment

As described above, the additive manufacturing powder 1 according to the embodiment is an additive manufacturing powder used for manufacturing the additively manufactured body 6 by the binder-jet method, and contains the metal particle 11 and the coating film 12 that is provided at the surface of the metal particle 11 and contains the compound derived from the coupling agent containing the amino group or the epoxy group. When 40 μL of water is dropped onto the powder layer formed by compressing the additive manufacturing powder 1 to have a relative density of 51%, a time for the water to infiltrate is 10.00 seconds or shorter.

According to such a configuration, it is possible to obtain the additive manufacturing powder 1 that can form the powder layer 31 in which the water-based binder solution 4 can infiltrate the target range without decreasing the supply speed of the binder solution 4. By using the additive manufacturing powder 1, the additively manufactured body 6 having a high surface area degree can be efficiently produced.

In the additive manufacturing powder 1 according to the embodiment, the coupling agent may contain a secondary amine.

According to such a configuration, it is possible to obtain the coating film 12 having a better affinity with the water-based binder solution 4.

In the additive manufacturing powder 1 according to the embodiment, the coupling agent may contain an amino group. In this case, when the additive manufacturing powder 1 is subjected to the infrared spectroscopic analysis, the obtained infrared absorption spectrum has the peak P1 derived from the siloxane bond and the peak P2 derived from the amino group, and the intensity of the peak P2 is 5% or more of the intensity of the peak P1.

According to such a configuration, a presence ratio of the amino group to the surface of the additive manufacturing powder 1 can be sufficiently high. As a result, the additive manufacturing powder 1 that can form the powder layer 31 in which the water infiltration rate is particularly optimized is obtained.

In the additive manufacturing powder 1 according to the embodiment, the coupling agent may contain an epoxy group. In this case, when the additive manufacturing powder 1 is subjected to the infrared spectroscopic analysis, the obtained infrared absorption spectrum has the peak P1 derived from the siloxane bond and the peak P3 derived from the epoxy group, and the intensity of the peak P3 is 5% or more of the intensity of the peak P1.

According to such a configuration, a presence ratio of the epoxy group to the surface of the additive manufacturing powder 1 can be sufficiently high. As a result, the additive manufacturing powder 1 that can form the powder layer 31 in which the water infiltration rate is particularly optimized is obtained.

In the additive manufacturing powder 1 according to the embodiment, the coverage ratio of the coating film 12 with respect to the surface of the metal particle 11 is preferably 10% or more and 150% or less.

According to such a configuration, it is possible to obtain the additive manufacturing powder 1 that can form the powder layer 31 in which the water-based binder solution can infiltrate the target range without decreasing the supply speed of the binder solution 4. In addition, in a case where a part of the surface of the metal particle 11 is exposed, a high affinity between the metal particle 11 and the water-based binder solution 4 can be obtained, and thus the infiltration rate can be further increased. As a result, the additively manufactured body 6 having a high surface area degree can be produced more efficiently.

The additively manufactured body 6 according to the embodiment contains the additive manufacturing powder 1 according to the embodiment and a binder that binds particles of the additive manufacturing powder 1.

According to such a configuration, the additively manufactured body 6 having a high surface area degree is obtained.

Although the additive manufacturing powder and the additively manufactured body of the disclosure have been described above based on the shown embodiment, the disclosure is not limited thereto. For example, the additive manufacturing powder and the additively manufactured body of the disclosure may be obtained by adding any component to the above-described embodiment.

### EXAMPLES

Next, specific examples of the disclosure will be described.

### 5. Production of Additive Manufacturing Powder

First, a metal powder used as an additive manufacturing powder in each of samples No. 1 to No. 17 was produced by a water atomization method. A constituent material of the metal powder was precipitation-hardening stainless steel SUS630 (17-4PH). Next, a coating film was formed at each obtained metal powder using a coupling agent. A reaction of the coupling agent and a subsequent heat treatment were performed in a state in which the metal powder and the coupling agent were charged in a sealed container. Accordingly, an additive manufacturing powder was obtained.

Next, an average particle diameter (particle diameter D50) of the produced additive manufacturing powder, a functional group of the coupling agent, the number of carbon atoms of a spacer, a compound of the coupling agent, an intensity ratio of a peak P2 or P3 to a peak P1, a coverage ratio of the coating film, a water contact angle, a bulk density, a tapped density, and a water infiltration time were measured. Measurement results are shown in Table 1.

Compounds shown in Table 1 are as follows.
Compound A-1:3-aminopropyltrimethoxysilane
Compound A-2: N-(2-aminoethyl)-3-aminopropyltrimethoxysilane
Compound A-3: N-2-(aminoethyl)-8-aminooctyltrimethoxysilane
Compound A-4:3-glycidoxypropyltrimethoxysilane
Compound A-5:3-glycidoxypropyltriethoxysilane
Compound B-1: propyltrimethoxysilane
Compound C-1: trimethoxy (11-pentafluorophenoxyundecyl)silane represented by the following formula (C-1)

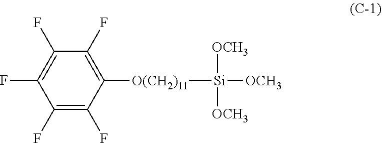

Compound C-2: pentafluorophenyldimethylchlorosilane represented by the following formula (C-2)

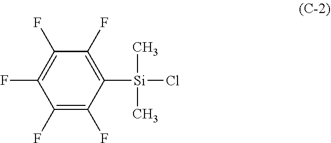

In Table 1, an additive manufacturing powder corresponding to the disclosure was referred to as an “Example”, and an additive manufacturing powder not corresponding to the disclosure was referred to as a “Comparative Example”.

### 6. Evaluation of Fillability of Additive Manufacturing Powder

A heat treatment was applied to 50 g of the additive manufacturing powder of each sample number for 24 hours at 200° C. under an ambient atmosphere. Next, the additive manufacturing powder after the heat treatment was charged into a 50 mL screw-cap vial. Next, a height from a bottom surface to an upper surface of the powder was measured in a state in which the screw-cap vial was erected. Then the measured height was compared to the following evaluation criteria to relatively evaluate fillability of the additive manufacturing powder. Evaluation results are shown in Table 1.
A: the height is 25 mm or lower (the fillability is particularly high)
B: the height is more than 25 mm and 30 mm or lower (the fillability is slightly high)
C: the height is more than 30 mm (the fillability is low)

### 7. Evaluation of Surface Accuracy of Additively Manufactured Body

First, using the additive manufacturing powder of each sample number, an additively manufactured body having a rectangular parallelepiped shape was manufactured by a binder-jet method. A size of the prepared additively manufactured body was 40 mm in length, 20 mm in width, and 5 mm in thickness. A PVP aqueous solution containing 10 mass % of PVP, 12 mass % of a humectant, and pure water as the remainder was used as the binder solution.

Next, the obtained additively manufactured body was observed with a digital microscope having a function as a non-contact type surface roughness measuring apparatus. Next, an arithmetic average roughness Ra of a surface of the additively manufactured body was measured based on an observation result. Then, a measurement result was compared to the following evaluation criteria to relatively evaluate surface accuracy of the additively manufactured body. Evaluation results are shown in Table 1.
A: the arithmetic average roughness Ra is 4.0 μm or less (the surface accuracy is particularly high)
B: the arithmetic average roughness Ra is more than 4.0 μm and 7.0 μm or less (the surface accuracy is slightly high)
C: the arithmetic average roughness Ra is more than 7.0 μm (the surface accuracy is low)

TABLE 1

| | | Configuration of additive manufacturing powder | | | | | |
|---|---|---|---|---|---|---|---|
| | | Average | | | | | |
| | | particle | Coupling agent | | | | Intensity |
| | | diameter of | | Number of | | | ratio of |
| | | additive | | carbon | | | peak P2 |
| | | manufacturing | Functional | atoms of | | Secondary | or P3 to |
| Sample | | powder | group | spacer | Compound | amine | peak P1 |
| No. | Classification | μm | — | Pieces | — | — | % |
| 1 | Example | 2.0 | Amino group | 3 | A-1 | No | 16 |
| 2 | Example | 6.5 | Amino group | 3 | A-1 | No | 5 |
| 3 | Example | 6.5 | Amino group | 3 | A-1 | No | 18 |
| 4 | Example | 7.2 | Amino group | 3 | A-1 | No | 25 |
| 5 | Example | 6.5 | Amino group | 3 | A-1 | No | 40 |
| 6 | Example | 6.5 | Amino group | 5 | A-2 | Yes | 12 |
| 7 | Example | 7.2 | Amina group | 5 | A-2 | Yes | 35 |
| 8 | Example | 6.5 | Amino group | 8 | A-3 | Yes | 8 |
| 9 | Example | 2.0 | Epoxy group | 4 | A-4 | No | 25 |
| 10 | Example | 6.5 | Epoxy group | 4 | A-4 | No | 34 |
| 11 | Example | 6.5 | Epoxy group | 4 | A-4 | No | 56 |
| 12 | Example | 7.2 | Epoxy group | 4 | A-4 | No | 65 |
| 13 | Example | 9.0 | Epoxy group | 4 | A-5 | No | 8 |
| 14 | Comparative | 6.5 | Alkyl group | — | B-1 | No | — |
| | Example | | | | | | |
| 15 | Comparative | 6.5 | Phenyl group | 11 | C-1 | No | — |
| | Example | | | | | | |
| 16 | Comparative | 6.5 | Phenyl group | 0 | C-2 | No | — |
| | Example | | | | | | |
| 17 | Comparative | 6.5 | Phenyl group | 0 | C-2 | No | — |
| | Example | | | | | | |

| | | | | | | Evaluation result | |
|---|---|---|---|---|---|---|---|
| | Configuration of additive manufacturing powder | | | | | | Surface |
| | Coverage | | | | | Fillability | accuracy of |
| | ratio of | Water | Bulk | Tapped | Water | of additive | additively |
| | coating | contact | density | density | infiltration | manufacturing | manufactured |
| Sample | film | angle | A. D | T. D | time | powder | body |
| No. | % | ° | g/cm³ | g/cm³ | seconds | — | — |
| 1 | 20 | 96 | 3.15 | 4.70 | 0.36 | B | A |
| 2 | 10 | 82 | 2.85 | 3.70 | 0.03 | B | B |
| 3 | 25 | 101 | 3.36 | 4.39 | 0.52 | A | A |
| 4 | 50 | 108 | 3.34 | 4.38 | 0.55 | A | A |
| 5 | 70 | 115 | 3.36 | 4.49 | 0.69 | A | B |
| 6 | 45 | 103 | 3.28 | 4.34 | 0.72 | A | A |
| 7 | 80 | 110 | 3.30 | 4.36 | 0.75 | A | A |
| 8 | 20 | 120 | 3.38 | 4.45 | 1.56 | A | B |
| 9 | 18 | 95 | 3.12 | 4.65 | 0.40 | B | A |
| 10 | 50 | 102 | 3.25 | 4.32 | 0.88 | A | A |
| 11 | 90 | 123 | 3.40 | 4.42 | 1.85 | A | B |
| 12 | 120 | 125 | 3.42 | 4.45 | 2.05 | A | B |
| 13 | 15 | 84 | 2.95 | 3.80 | 0.05 | B | B |
| 14 | 50 | 130 | 3.50 | 4.70 | 11.50 | A | C |
| 15 | 40 | 145 | 3.80 | 4.80 | 32.00 | A | C |
| 16 | 30 | 140 | 3.75 | 4.75 | 25.00 | A | C |
| 17 | 150 | 150 | 3.85 | 4.85 | 35.00 | A | C |

As shown in Table 1, in each Example, it was found that the fillability of the additive manufacturing powder was sufficiently high, and the additively manufactured body produced using the additive manufacturing powder had high surface accuracy.

In contrast, the additively manufactured body produced using the additive manufacturing powder of each Comparative Example had low surface accuracy. It is recognized that such a result is caused by an affinity between the additive manufacturing powder and the water-based binder solution.

What is claimed is:

1. An additive manufacturing powder used for producing an additively manufactured body by a binder-jet method, the additive manufacturing powder comprising:
a metal particle; and
a coating film provided at a surface of the metal particle and containing a compound derived from a coupling agent containing an amino group or an epoxy group, wherein
when 40 μL of water is dropped onto a powder layer formed by compressing to have a relative density of 51%, a time for the water to infiltrate is 10.00 seconds or shorter.

2. The additive manufacturing powder according to claim 1, wherein
the coupling agent contains a secondary amine.

3. The additive manufacturing powder according to claim 1, wherein
the coupling agent contains an amino group,
when the additive manufacturing powder is subjected to an infrared spectroscopic analysis, an obtained infrared absorption spectrum has a peak P1 derived from a siloxane bond and a peak P2 derived from the amino group, and
an intensity of the peak P2 is 5% or more of an intensity of the peak P1.

4. The additive manufacturing powder according to claim 1, wherein
the coupling agent contains an epoxy group,
when the additive manufacturing powder is subjected to an infrared spectroscopic analysis, an obtained infrared absorption spectrum has a peak P1 derived from a siloxane bond and a peak P3 derived from the epoxy group, and
an intensity of the peak P3 is 5% or more of an intensity of the peak P1.

5. The additive manufacturing powder according to claim 1, wherein
a coverage ratio of the coating film to the surface of the metal particle is 10% or more and 150% or less.

6. An additively manufactured body comprising:
the additive manufacturing powder according to claim 1; and
a binder that binds particles of the additive manufacturing powder.
